(19) United States
(12) Patent Application Publication
(10) Pub. No.: US 2008/0051549 A1
(43) Pub. Date: Feb. 28, 2008

(54) Diluent free epoxy resin formulation

(75) Inventors: Cherif Ghoul, Mulhouse (FR); Xavier Kornmann, Lauchringen (DE); Saija Paakkonen, Helsinki (FI); Hans-Ake Eriksson, Vasteras (SE); Osmo Koponen, Espoo (FI); Stefano Chieregato, Cremona (IT)

Correspondence Address: BUCHANAN, INGERSOLL & ROONEY PC, POST OFFICE BOX 1404, ALEXANDRIA, VA, 22313-1404, US

(73) Assignee: ABB Research LTD, Zurich (CH)

(21) Appl. No.: 11/826,942

(22) Filed: Jul. 19, 2007

(30) Foreign Application Priority Data
Jul. 20, 2006 (EP) 06405315.0

(51) Int. Cl. C08G 59/20; H01B 3/40; H01B 7/00; H01F 27/02

(52) U.S. Cl. 528/91; 174/110 E; 174/121 R; 336/96; 528/103; 528/92

(57) ABSTRACT

An epoxy resin formulation is disclosed. Such a formulation is suitable for the use as coil insulation material, wherein the formulation includes (a) a purified grade of at least one diglycidyl ether of a bisphenol compound or at least one cycloaliphatic diglycidyl ether compound or a mixture of such compounds, wherein the compounds have an epoxy equivalent weight not exceeding 10% of the minimum epoxy equivalent weight calculated for each compound; and (b) the formation optionally includes up to 50% by weight of a diglycidyl ether of a bisphenol compound or of a cycloaliphatic diglycidyl ether compound or a novolac epoxy or a mixture of such compounds, wherein the compounds have an epoxy equivalent weight exceeding 10% of the minimum epoxy equivalent weight calculated for each compound; and (c) a polymerization catalyst.

### CROSS REFERENCE TO RELATED APPLICATION

The present application claims priority under 35 U.S.C. §119 to European Application No. 06405315.0 filed Jul. 20, 2006, the contents of which are hereby incorporated by reference in their entirety.

### BACKGROUND

1. Field

An epoxy resin formulation is disclosed which can be used as coil insulation material.

2. Background Information

In electrical machines, curable resins have been used to impregnate insulation layers, such as mica paper, wound around an electric conductor, such as the coils of the stator. These resins act as a binder between the different layers and provide electrical insulation to the coil. A known way to diffuse the resin into the layers and the coil includes, for example, immersing a non-impregnated stator under vacuum in a resin bath and subsequently applying pressure. After several hours of impregnation, the stator is placed in an oven for curing of the resin. This process is known as the vacuum pressure impregnation (VPI) process.

The resin can have a sufficiently low viscosity to impregnate thick layers of mica tape used in electrical machines. To obtain this low viscosity, polymer systems like anhydride cured epoxies, polyesterimides, or mixtures of both resins have been used. These systems have a low viscosity because one of their components, e.g. the anhydride in an anhydride cured epoxy resin composition, acts as a diluent. These diluents can evaporate during the impregnation and the curing processes, which can be a potential danger for the health of workers and for the environment.

In order to reduce the amount of emissions, it has been proposed to use catalyzed epoxies with small amounts of reactive diluents like polypropylene glycol, in order to obtain the desired low viscosity. VPI resins used in industry and newly proposed solutions to reduce the emissions during manufacturing contain diluents that can potentially evaporate during the VPI process.

### SUMMARY

An epoxy resin formulation is disclosed herein, comprising: a purified grade of at least one diglycidyl ether of a bisphenol compound or at least one cycloaliphatic diglycidyl ether compound or a mixture of such compounds, wherein said compounds have an epoxy equivalent weight not exceeding 10% of a minimum epoxy equivalent weight calculated for each compound [component (a)]; and a polymerization catalyst.

### DETAILED DESCRIPTION

An epoxy resin formulation, such as a diluent free specific catalyzed epoxy resin formulation is disclosed, which is suitable for use as, among other applications, a coil insulation material. The formulation has a sufficiently low viscosity at a temperature of about 50° C., which is, for example, generally the temperature level at which the impregnation process is carried out.

It has been found that when a purified grade of a diglycidyl ether of a bisphenol compound such as a diglycidyl ether of bisphenol A, a diglycidyl ether of bisphenol F, or a corresponding cycloaliphatic diglycidyl ether or a mixture of these compounds is used, wherein said compounds or said mixture of compounds have an epoxy equivalent weight (also named epoxide value) not exceeding 10% of the minimum epoxy equivalent weight of each compound, the impregnation process as described above can be carried out without the addition of a diluent at a process temperature of about 50° C. Preferred is, for example, a mixture of diglycidyl ether of bisphenol A and diglycidyl ether of bisphenol F. Variable ratios between diglycidyl ether of bisphenol A and diglycidyl ether of bisphenol F permit adjustment of the viscosity level of the resin whereby diglycidyl ether of bisphenol A also lowers the overall price of the resin. The mixture can have a very low tendency to crystallize.

An epoxy resin formulation as disclosed herein, such as a diluent free epoxy resin formulation, can be suitable for use as coil insulation material. An exemplary formulation includes a purified grade of at least one diglycidyl ether of a bisphenol compound or at least one cycloaliphatic diglycidyl ether compound or a mixture of such compounds, wherein the compounds have an epoxy equivalent weight not exceeding 10% of the minimum epoxy equivalent weight calculated for each compound [component (a)]. The formulation optionally further includes up to 50% by weight (calculated to the total weight of the formulation) of a diglycidyl ether of a bisphenol compound or of a cycloaliphatic diglycidyl ether compound or a novolac epoxy or a mixture of such compounds, wherein said compounds have an epoxy equivalent weight exceeding 10% of the minimum epoxy equivalent weight calculated for each compound [component (b)]. A polymerization catalyst can also be included.

A molded coil is disclosed which can be molded with the epoxy resin formulation as coil insulation material.

An electric conductor, such as an electric coil (e.g., an electric coil of a stator), is also disclosed, the electric conductor carrying an impregnated insulation layer, which can be made from mica paper, wound around an electric conductor. The impregnated insulation layer can be insulated with a diluent free epoxy resin formulation as coil insulation material.

The purified grade of the at least one diglycidyl ether of a bisphenol compound or of the at least one cycloaliphatic diglycidyl ether compound or a mixture of such compounds, wherein said compounds have an epoxy equivalent weight not exceeding 10% of the minimum epoxy equivalent weight calculated for each compound [component (a)] can be selected from the group comprising (e.g., consisting on diglycidyl ethers of bisphenol A, diglycidyl ethers of bisphenol F, and corresponding cycloaliphatic diglycidyl ethers.

The optional component (b) of the formulation which comprises up to 30% by weight of a diglycidyl ether of a bisphenol compound or of a cycloaliphatic diglycidyl ether compound or a novolac epoxy or a mixture of such compounds, wherein said compounds have an epoxy equivalent weight exceeding 10% of the minimum epoxy equivalent weight calculated for each compound can, for example, be selected from the group comprising (e.g., consisting of) diglycidyl ethers of bisphenol A, diglycidyl ethers of bisphenol F, and corresponding cycloaliphatic diglycidyl ethers. Novolac epoxy compounds can, for example, be selected from D.E.N. epoxies (Polyglycidyl ether of phenol-formaldehyde Novolac) from Dow Chemical Company like D.E.N. 431 for instance.

Diglycidyl ether of bisphenol A is represented by the following formula (I) 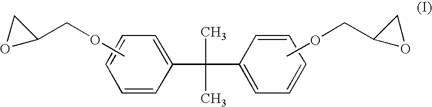
wherein the glycidyl ether substituent each time is, for example, in the para-position. Compound (I) has a calculated molecular weight of 340. Compound (I) carries two epoxy equivalents per 340 grams, which means that the calculated minimum epoxy equivalent weight for compound (I) is 170 [i.e. 340 divided by 2]. The minimum epoxy equivalent weight for compound (I) as contained in component (a) therefore should not, in exemplary embodiments, exceed the value of 187, i.e. the sum of [170+17], or other suitable value.

Diglycidyl ether of bisphenol F is represented by the following formula (II): 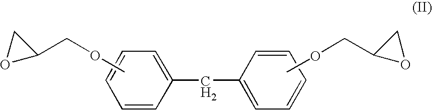
wherein the glycidyl ether substituent each time can be in the ortho or para-position, so that the compound can represent o,o′- or o,p′ or p,p′-bis(glycidyloxyphenyl)methane.

Compound (II) has a calculated molecular weight of 312. Compounds (II) carries two epoxy equivalents per 312 grams, which means that the calculated minimum epoxy equivalent weight for compound (II) is 156. The minimum epoxy equivalent weight for compound (II) as contained in component (a) therefore should not, for exemplary embodiments, exceed the value of 171.6, i.e. the sum of [156+15.6], or other suitable value.

As the glycidyl group can react relatively easily with hydroxyl groups there are formed polymers during production as is illustrated by the following formula (Ill): 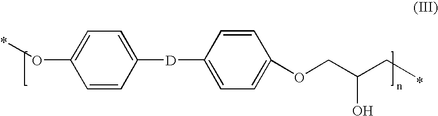
wherein D for example is —CH₂— or —C(CH₃)₂—. This explains why a certain glycidyl ether may have different values for the epoxy equivalent weight.

Component (a) is a purified grade of at least one diglycidyl ether of a bisphenol compound or at least one cycloaliphatic diglycidyl ether compound or a mixture of such compounds, wherein said compounds have an epoxy equivalent weight not exceeding 10% of the minimum epoxy equivalent weight calculated for each compound. In exemplary embodiments, the compound or compounds of component (a) have an epoxy equivalent weight not exceeding a value of or about 8%, preferably not exceeding 6%, preferably not exceeding 5%, preferably not exceeding 4%, preferably not exceeding 3% and preferably not exceeding 2% of the minimum epoxy equivalent weight calculated for each compound.

The optional component (b) comprises up to 50% by weight of a diglycidyl ether of a bisphenol compound or of a cycloaliphatic diglycidyl ether compound or a novolac epoxy or a mixture of such compounds, wherein said compounds have an epoxy equivalent weight exceeding 10% of the minimum epoxy equivalent weight calculated for each compound. In exemplary embodiments, the compound or the compounds of component (b) have an epoxy equivalent weight exceeding the minimum epoxy equivalent weight in the range of or about 12 to 20%, preferably within the range of 12 to 15% calculated for each compound. However the amount of the difference to the minimum epoxide value is not critical as long as the viscosity at about 50° C. remains low enough for the reaching the purposes of the embodiments described herein. The viscosity is within an exemplary viscosity range of or about of from 50 to 400 mPa.s. at a temperature of or about 50° C. Combining the components (a) and (b) in order to obtain the required viscosity of the mixture is within the general knowledge of those skilled in the art.

Diglycidyl ethers of bisphenol A and diglycidyl ethers of bisphenol F are known in the art and need no further explanation.

The formulation optionally further comprises up to or about 50% by weight of component (b), i.e., a diglycidyl ether of a bisphenol compound or of a cycloaliphatic diglycidyl ether compound or a novolac epoxy or a mixture of such compounds as defined above. In exemplary embodiments, the formulation optionally further comprises of or about 10-30% by weight, preferably 15-30% by weight, of said component (b), calculated to the total weight of the formulation.

In exemplary embodiments, component (a) comprises a mixture of diglycidyl ether of bisphenol A and diglycidyl ether of bisphenol F, wherein the ratio of diglycidyl ether of bisphenol A to diglycidyl ether of bisphenol F is within the range of or about 10:90 to 50:50% by weight, preferably within the range of 20:80 to 40:60% by weight, and preferably at about 25:75% by weight.

In exemplary embodiments, component (a) comprises a mixture of a cycloaliphatic diglycidyl ether, preferably EPR 758 from Bakelite or CY 184 from Huntsman and diglycidyl ether of bisphenol F, wherein the ratio of the cycloaliphatic diglycidyl ether to diglycidyl ether of bisphenol F is within the range of or about 10:90 to 40:60% by weight, preferably within the range of 20:80 to 30:70% by weight, and preferably at about 25:75% by weight.

The polymerization catalyst can be, for example, chosen from boron trichloride-amine complexes, boron trifluoride-amine complexes, organotin complexes, metal acetylacetonate with phenolic accelerators and other known latent catalysts which do not initiate polymerization at room temperature. The polymerization catalyst can be used in concentrations within the range of or about 0.5% to 5% by weight, preferably within a concentration of about 1% to 3% by weight. Such catalysts are commercially available, for example as Leecure 38-239B from Leepoxy, DY 9577 from Huntsman, EPX 04552 from Bakelite, or Omicure BC-120 from CVC Specialty Chemicals.

The impregnation process and the polymerization of the composition according to exemplary embodiments described herein can be handled in a manner known per se. Also the vacuum pressure impregnation (VPI) process can be used.

The following examples illustrate exemplary embodiments without limiting the invention.

### EXAMPLE 1

The diluent free resin formulation preparation does not require sophisticated equipment. First, the crystallized diglycidyl ether of bisphenol F resin is melted at or about 50° C. Then, the defined amount of diglycidyl ether of bisphenol A is added and the mixture is stirred. The defined amount of catalyst is then added and the mixture is stirred again. The mixture is then ready to be used for making an insulation as described in the specification. Table 1 presents several examples of the formulation. Example D is a comparative example.

The diglycidyl ether of bisphenol F resin has an epoxy equivalent weight of 157 to 167 which is 0.6 to 7% more than the calculated minimum epoxy equivalent weight said compound.

The diglycidyl ether of bisphenol A resin has an epoxy equivalent weight of 171 to 176 which is 0.6 to 4% more than the calculated minimum epoxy equivalent weight said compound.

TABLE 1

| | Composition: | | | |
|---|---|---|---|---|
| | A | B | C | D |
| Diglycidyl ether of Bisphenol F/phr | 75 | 75 | 75 | 75 |
| Diglycidyl ether of Bisphenol A/phr | 25 | 25 | 25 | 25 |
| Polypropylene Glycol/phr | | | | 3 |
| Boron trichloride-amine complex/phr | 2 | 2.5 | 3 | 2.5 |
| Processing Properties: | | | | |
| Gel time at 165° C./min | 12 | 11 | 6 | 9 |
| Time to 300 mPa · s | 48 | 37 | 32 | 35 |
| at 50° C./days | | | | |
| Viscosity at 25° C./mPa · s | 1830 | 1830 | 1830 | 1380 |
| Viscosity at 50° C./mPa · s | 161 | 160 | 170 | 158 |
| Other Properties: | | | | |
| Tg after cure 10 h | 125 | 130 | 139 | 123 |
| at 165° C./° C. | | | | |
| Dielectric losses | 24 | 30 | 32 | 30 |
| tan δ at 130° C. × 10⁻³ | | | | |

“phr” stands for “parts per hundred resin”. The term resin corresponds in this case to the mixture of diglycidyl ethers of bisphenol A & F.

Discussion of Results
1. Comparison of Compositions A, B, C with Composition D:

The addition of 3 phr of a reactive diluent (polypropylene glycol) in composition D reduces the viscosity of the formulation at 25° C. from 1830 to 1380 mPa.s. Even if the viscosity has been reduced, this level of viscosity can still be too high for a room temperature impregnation. When the temperature is increased to 50° C., no significant effect of the reactive diluent can be seen on the viscosity. This illustrates the fact that a reactive diluent, e.g. polypropylene glycol, is not necessary to insure a good impregnation. The presence of diluent does not extend the tank stability at 50° C. (time to 300 mPa.s at 50° C.) or increase the dielectric losses of the resulting material at 130° C.

2. Comparison Between Composition A, Composition B, and Composition C:

Decreasing the amount of catalyst increases the tank stability at 50° C. and increases the gel time at 165° C. The glass transition temperature of the resulting material decreases but to a limited extent. The amount of catalyst can be tuned to get the right balance between an optimal tank stability at 50° C. and a sufficiently low gel time at 165° C. to minimize dripping of the resin upon cure. The decrease of the amount of catalyst can have a limited effect on the dielectric losses of the material at 130° C.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An epoxy resin formulation, comprising:
a purified grade of at least one diglycidyl ether of a bisphenol compound or at least one cycloaliphatic diglycidyl ether compound or a mixture of such compounds, wherein said compounds have an epoxy equivalent weight not exceeding 10% of a minimum epoxy equivalent weight calculated for each compound [component (a)]; and
a polymerization catalyst.

2. A formulation according to claim 1, wherein the at least one diglycidyl ether of a bisphenol compound or the at least one cycloaliphatic diglycidyl ether compound of component (a) is selected from the group consisting of diglycidyl ethers of bisphenol A, diglycidyl ethers of bisphenol F, and corresponding cycloaliphatic diglycidyl ethers.

3. A formulation according to claim 16, wherein said diglycidyl ether of a bisphenol compound or said cycloaliphatic diglycidyl ether compound or said novolac epoxy of component (b) is selected from the group consisting of diglycidyl ethers of bisphenol A, diglycidyl ethers of bisphenol F, and corresponding cycloaliphatic diglycidyl ethers.

4. A formulation according to claim 16, wherein said novolac epoxy compound is selected from D.E.N. epoxies from Dow Chemical Company.

5. A formulation according to claim 2, wherein the diglycidyl ether of bisphenol F is o,o′- or o,p′ or p,p′-bis(glycidyloxyphenyl)methane.

6. A formulation according to claim 1, wherein component (a) has an epoxy equivalent weight not exceeding 8% of the minimum epoxy equivalent weight calculated for each compound.

7. A formulation according to claim 16, wherein component (b) has an epoxy equivalent weight exceeding the minimum epoxy equivalent weight in a range of 12 to 20% calculated for each compound.

8. A formulation according to claim 1, wherein the formulation has a viscosity within a range of from 50 to 400 mPa.s., at 50° C.

9. A formulation according to claim 16, comprising:
10-30% by weight of component (b), calculated to a total weight of the formulation.

10. A formulation according to claim 1, wherein component (a) comprises a mixture of diglycidyl ether of bisphenol A and diglycidyl ether of bisphenol F, wherein a ratio of diglycidyl ether of bisphenol A to diglycidyl ether of bisphenol F is within a range of 10:90 to 50:50% by weight.

11. A formulation according to claim 1, wherein component (a) comprises:
a mixture of a cycloaliphatic diglycidyl ether, and diglycidyl ether of bisphenol F, wherein a ratio of the cycloaliphatic diglycidyl ether to diglycidyl ether of bisphenol F is within a range of 10:90 to 40:60% by weight.

12. A formulation according to claim 1, wherein the polymerization catalyst is at least one of boron trichloride-amine complexes, boron trifluoride-amine complexes, organotin complexes, metal acetylacetonate with phenolic accelerators and other known latent catalysts which do not initiate polymerization at room temperature.

13. A formulation according to claim 12, wherein the polymerization catalyst is present in concentrations within the range of 0.5% to 5% by weight.

14. A molded coil, wherein the coil is molded with a coil insulation material formed from an epoxy resin formulation according to claim 1.

15. An electric conductor having an impregnated insulation layer wound around the electric conductor, said impregnated insulation layer being insulated with a coil insulation material formed as an epoxy resin formulation according claim 1.

16. An epoxy resin formulation according to claim 1, comprising up to 50% by weight (calculated to the total weight of the formulation) of a diglycidyl ether of a bisphenol compound or of a cycloaliphatic diglycidyl ether compound or a novolac epoxy or a mixture of such compounds, wherein said compounds have an epoxy equivalent weight exceeding 10% of the minimum epoxy equivalent weight calculated for each compound [component (b)].

17. An epoxy resin formulation according to claim 4, wherein said novolac epoxy compound is D.E.N. 431.

18. A formulation according to claim 3, wherein the diglycidyl ether of bisphenol F is o,o′- or o,p′ or p,p′-bis(glycidyloxyphenyl)methane.

19. A formulation according to claim 1, wherein component (a) has an epoxy equivalent weight not exceeding 6% of the minimum epoxy equivalent weight calculated for each compound.

20. A formulation according to claim 1, wherein component (a) has an epoxy equivalent weight not exceeding 5% of the minimum epoxy equivalent weight calculated for each compound.

21. A formulation according to claim 1, wherein component (a) has an epoxy equivalent weight not exceeding 4% of the minimum epoxy equivalent weight calculated for each compound.

22. A formulation according to claim 1, wherein component (a) has an epoxy equivalent weight not exceeding 3% of the minimum epoxy equivalent weight calculated for each compound.

23. A formulation according to claim 1, wherein component (a) has an epoxy equivalent weight not exceeding 2% of the minimum epoxy equivalent weight calculated for each compound.

24. A formulation according to claim 16, wherein component (b) has an epoxy equivalent weight exceeding the minimum epoxy equivalent weight in a range of 12 to 15% calculated for each compound.

25. A formulation according to claim 16, comprising:
15-30% by weight of component(b), calculated to a total weight of the formulation.

26. A formulation according to claim 1, wherein component (a) comprises a mixture of diglycidyl ether of bisphenol A and diglycidyl ether of bisphenol F, wherein a ratio of diglycidyl ether of bisphenol A to diglycidyl ether of bisphenol F is within a range of 20:80 to 40:60% by weight.

27. A formulation according to claim 1, wherein component (a) comprises a mixture of diglycidyl ether of bisphenol A and diglycidyl ether of bisphenol F, wherein a ratio of diglycidyl ether of bisphenol A to diglycidyl ether of bisphenol F is within a range of 25:75% by weight.

28. A formulation according to claim 1, wherein component (a) comprises:
a mixture of a cycloaliphatic diglycidyl ether, wherein the cycloaliphatic diglycidyl ether is, EPR 758 from Bakelite and CY 184 from Huntsman and diglycidyl ether of bisphenol F, wherein a ratio of the cycloaliphatic diglycidyl ether to diglycidyl ether of bisphenol F is within the range of 10:90 to 40:60% by weight.

29. A formulation according to claim 1, wherein component (a) comprises:
a mixture of a cycloaliphatic diglycidyl ether, and diglycidyl ether of bisphenol F, wherein a ratio of the cycloaliphatic diglycidyl ether to diglycidyl ether of bisphenol F is within the range of 20:80 to 30:70% by weight.

30. A formulation according to claim 1, wherein component (a) comprises:
a mixture of a cycloaliphatic diglycidyl ether, and diglycidyl ether of bisphenol F, wherein a ratio of the cycloaliphatic diglycidyl ether to diglycidyl ether of bisphenol F is within the range of about 25:75% by weight.

31. A formulation according to claim 12, wherein the polymerization catalyst is present in concentrations within the range of 1% to 3% by weight.

32. The electric conductor according to claim 15, wherein the impregnated insulation layer is made from mica paper.
